(19) United States
(12) Patent Application Publication
(10) Pub. No.: US 2007/0239346 A1
(43) Pub. Date: Oct. 11, 2007

(54) System and Method of Receiving Data from a Plurality of Trucking Companies and Disseminating Data to a Plurality of Parties

(75) Inventors: Russell C. Hawkins, Tampa, FL (US); Robert V. Helms, Tampa, FL (US)

Correspondence Address: AKERMAN SENTERFITT, P.O. BOX 3188, WEST PALM BEACH, FL, 33402-3188, US

(73) Assignee: Pegasus TransTech Corporation, Tampa, FL (US)

(21) Appl. No.: 11/278,775

(22) Filed: Apr. 5, 2006

(51) Int. Cl. G08G 1/00

(52) U.S. Cl. 701/117

(57) ABSTRACT

A system and method are provided for aggregating data from multiple client terminals that are located on a vehicle, processing the data and communicating the processed data to multiple agencies. The client terminal devices are coupled to vehicle engine data bus to provide performance data and location data for trucks that travel in commerce. The data may be provided in real-time.

### FIELD OF THE INVENTION

The invention relates to a system and method of aggregating data from multiple devices, processing the data, and communicating the processed data to multiple agencies to address public interest issues. In particular, the invention relates to a system and method of aggregating data from multiple devices that reside on a vehicle, processing the data, and communicating the processed data to multiple government agencies and/or non-government agencies to provide traffic, safety, environmental and security information.

### BACKGROUND OF THE INVENTION

Currently, commercial truckers experience extensive delay times within port terminals. The commercial trucks pick-up and deliver containers from the port terminals and need to be informed about wait-times so that alternate plans may be employed. Various other drawbacks exist with this system and with other systems known in the prior art.

A system is needed that provides real-time monitoring of trucks within these port terminals and along highways and enables notifications to be generated to a plurality of agencies and/or truckers so that actions may be taken to alleviate the extensive wait-times.

### SUMMARY OF THE INVENTION

Various aspects of the invention overcome at least some of these and other drawbacks of existing systems. According to another embodiment of the invention, one or more client terminal devices may be assigned to at least one vehicle. The client terminal devices may include several modules, such as a user interface module, an authorization module, a communications module, a global positioning module, software, and a memory.

According to another embodiment of the invention, one or more client terminal devices may be assigned directly or indirectly to a user. According to another embodiment of the invention, client terminal devices may include an authentication module that requests user credentials and validates users as registered users.

According to one embodiment of the invention, client terminal devices may include at least a first unique identifier that is associated with the vehicle in which the client terminal device is located. According to another embodiment of the invention, client terminal devices may include at least a second unique identifier that is associated with at least one trucking company that operates or otherwise manages operations of corresponding vehicle.

According to one embodiment of the invention, client terminal devices may be coupled to a vehicle engine data bus to collect performance data. Client terminal devices also may include a global positioning module that captures global positioning data and/or other data corresponding to vehicle.

According to one embodiment of the invention, a server may be provided that includes a communications module, an identifying module, a sorting module, a categorizing module a metrics module and an aggregation module. According to an alternative embodiment, an intermediate server may be provided along with server. Intermediate server may include a communications module, a merging module, a forwarding module and a snap-shot module, whereas the server may include a communications module, a metrics module and an aggregation module.

According to another embodiment of the invention, the server may include a notification module that generates notifications and/or alerts that are directed to a plurality of parties including government agencies, non-government agencies, dispatchers, vehicle operators, service subscribers, and/or other parties. The notifications and/or alerts may be generated based on various triggers. In an alternative embodiment, the notifications and/or alerts also may be generated based on watches that are set-up to monitor captured data, vehicle company data, metrics information, and global positioning data for particular criteria.

The invention provides numerous advantages over and avoids many drawbacks of prior systems. These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should become apparent upon a reading of the following detailed description when taken in conjunction with the accompanying drawings, a brief description of which is included below.

### BRIEF DESCRIPTION OF THE DRAWINGS

The drawings appended hereto are intended to illustrate contemplated embodiments of the invention. The drawings are not intended to limit the invention solely to the embodiments illustrated and described.

FIG. 1 illustrates a system diagram according to first embodiment of the invention.

FIG. 2 illustrates a system diagram according to a second embodiment of the invention.

FIG. 3 illustrates a flow chart for gathering data from a plurality of terminal devices and notifying a plurality of agencies of the results.

### DETAILED DESCRIPTION OF THE INVENTION

The invention provides a vehicle monitoring and notification system for use in a trucking industry. Freight flows have increased substantially in recent years creating congestion in the transportation system. The increased congestion imposes a cost on shippers, consumers and the environment In particular, the freight system faces significant capacity constraints at key freight gateways, such a port terminals. A system is needed that will provide efficient, reliable, safe and secure movement of goods, while improving environmental quality. In order to attain this goal, a system is needed that will reduce traffic, thereby reducing pollution. Additionally, a system is needed that will enhance security for the transportation of hazardous materials, thereby increasing public safety.

One solution involves using truck mounted real-time communication devices to gather information during a normal course of business. The information is gathered from trucks that are affiliated with a plurality of trucking companies. The information is provided to a centralized data base, where the information may be aggregated and processed. The processed results may be provided to a plurality of governmental agencies and/or a plurality of non-governmental agencies. Additionally, the processed results may be relied on to enforce legislation.

One aspect of the system involves installing client terminal device in a vehicle. The client terminal device may be associated with at least one trucking company and may include a global positioning system that generates global positioning data. Data may be captured and forwarded to an intermediate server that is associated with a trucking company. The intermediate server may receive the captured client terminal data and may merge the captured client terminal data into trucking company data for a particular trucking company. The intermediate server may provide the benefit of allowing the affiliated trucking company to control access to the trucking company data.

The trucking company data may be forwarded from the intermediate servers to a data aggregation server that receives trucking company data from a plurality of trucking companies. A metrics module may be included in the data aggregation server that utilizes the trucking company data and determines metrics information corresponding to at least one vehicle and at least one trucking company. An aggregation module may analyze the trucking company data and/or the metrics information to record aggregated data. The vehicle monitoring and notification system is configured to report the captured client terminal data, the trucking company data, and the metrics information to a plurality of government agencies, a plurality of non-government agencies, or both.

While specific embodiments of the invention are discussed herein and are illustrated in the drawings appended hereto, the invention encompasses a broader spectrum than the specific subject matter described and illustrated. As would be appreciated by those skilled in the art, the embodiments described herein provide but a few examples of the broad scope of the invention. There is no intention to limit the scope of the invention only to the embodiments described herein.

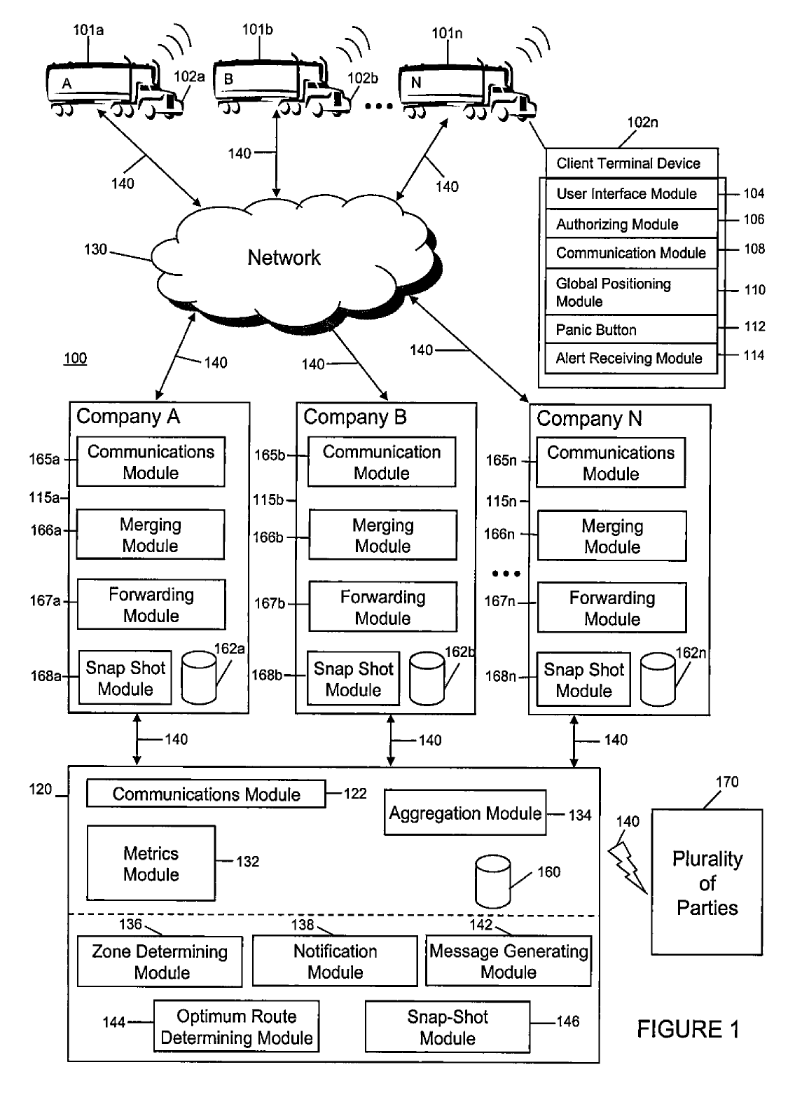

Widespread use of computer networks offers great potential for automating information gathering and dissemination, both as an enabling infrastructure and as a platform for supporting new applications. FIG. 1 illustrates an example of the system architecture 100 according to one embodiment of the invention. Client terminal devices 102a, 102b, 102n (102a-102n) intermediate servers 115a, 115b, 115n (115a-115n) and one or more servers 120 may be connected via a wired network, a wireless network, a combination of the foregoing and/or other network(s) (for example the Internet) 130. According to one embodiment of the invention, client terminals 102a-102n reside in vehicles 101a, 101b, and 101n (101a-101n), respectively, wherein vehicle 101a may be affiliated or otherwise identified with company A, vehicle 101b may be affiliated or otherwise identified with company B and vehicle 101n may be affiliated or otherwise identified with company N.

According to another embodiment of the invention, intermediate servers 115a-115n may be company affiliated servers, wherein intermediate server 115a may be affiliated or otherwise identified with company A, intermediate server 115b may be affiliated or otherwise identified with company B and intermediate server 115n may be affiliated or otherwise identified with company N. It will be readily understood that “company” may include any organizations having items, such as objects, data, and other items that are intended to be identified collectively.

According to one embodiment of the invention, client terminal devices 102a-102n may include any number of different types of client terminal devices, such as personal computers, laptops, smart terminals, personal digital assistants (PDAs), cell phones, portable processing, devices that combine the functionality of one or more of the foregoing or other client terminal devices.

According to another embodiment of the invention, client terminal devices 102a-102n may include several components, including a processor, RAM, a USB interface, a telephone interface, microphone, speakers, a stylus, a computer mouse, a wide area network interface, a local area network interface, a hard disk drive, a wireless communication interface, a DVD/CD reader/burner, a keyboard, a flat touch-screen display, a computer display, and/or other components. According to yet another embodiment of the invention, client terminal devices 102a-102n may include, or be modified to include, software that may operate to provide data gathering and data exchange functionality.

According to one embodiment of the invention, client terminal devices 102a-102n may include several modules. The modular construction facilitates adding, deleting, updating and/or amending modules therein and/or features within modules. Modules may include a user interface module 104, an authorization module 106, a communications module 108, a global positioning module 110, software, memory, and/or other modules. It should be readily understood that a greater or lesser number of modules might be used. One skilled in the art will readily appreciate that the invention may be implemented using individual modules, a single module that incorporates the features of two or more separately described modules, individual software programs, and/or a single software program.

According to one embodiment of the invention, user interface module 104 may support several features including a touch-sensitive display screen, voice recognition system, voice command system, a speaker, a microphone, input buttons, and/or other features. According to one embodiment, select functions may be implemented by positioning an indicator over selected icons and manipulating an input receiving device, such as the touch-sensitive display screen, a mouse, a keyboard, or other input receiving devices. According to another embodiment of the invention, select functions may be implemented using a voice recognition system to enable hands-free operation. According to yet another embodiment of the invention, client terminal devices 102a-102n may include a touch-sensitive display screen that is combined with an audio input device, such as a voice recognition system. According to an alternative embodiment, client terminal devices 102a-102n may include a video input device that permits audio-visual communication with other client terminal devices 102a-102n and/or other computer systems.

According to one embodiment of the invention, client terminal device 102a may communicate with intermediate server 115a via network 130, client terminal device 102b may communicate with intermediate server 115b via network 130 and client terminal device 102n may communicate with intermediate server 115n via network 130. According to another embodiment of the invention, a limited data exchange may be provided between non-affiliated companies so that individual companies may maintain control over sharing items with non-affiliated companies.

Client terminal devices 102a-102n may communicate via communications media 140, such as, for example, any wired and/or wireless media. Communications between client terminal devices 102a-102n and intermediate servers 115a-115n may occur substantially in real-time, if the system is connected to the network 130. One of ordinary skill in the art will appreciate that communications may be conducted in various ways and among various devices.

Communications via network 130 may be implemented using current and future language conventions and/or current and future communications protocols that are generally accepted and used for generating and/or transmitting messages over network 130. Language conventions may include Hypertext Markup Language (“HTML”), extensible Markup Language (“XML”) and other language conventions. Communications protocols may include, Hypertext Transfer Protocol (“HTTP”), TCP/IP, SSL/TLS, FTP, GOPHER, and/or other protocols.

According to another embodiment of the invention, client terminal devices 102a-102n may be assigned to corresponding vehicles 101a-101n. According to another embodiment of the invention, client terminal devices 102a-102n may be assigned directly or indirectly to a user. Regarding indirect assignment, a client terminal device 102a-102n may be assigned to vehicle 101a-101n and the user may be assigned to the same vehicle 101a-101n, thereby creating an association between client terminal devices 102a-102n and the user.

According to one embodiment of the invention, client terminal devices 102a-102n may be coupled to each other directly and/or indirectly and may communicate via communications module 108. Client terminal devices 102a-102n may include a communications module 108 that is coupled to media 140 such as, for example, any wireless and/or wired media. For example, a user may access client terminal device 102a-102n, which is located in an assigned vehicle 101a-101n, to request information. The request may be broadcast to a wireless client terminal device 102a-102n that is carried by a target recipient such as another vehicle operator, a dispatcher or other target recipient. Alternatively, communications module 108 may communicate with intermediate servers 115a-15n and/or server 120 to exchange data, wherein the data exchange may occur with or without user awareness of the data exchange. Communications with client terminal devices 102a-102n may occur substantially in real-time if the client terminal devices 102a-102n are connected to network 130.

Alternatively, the communications may be delayed for an amount of time if, for example, one or more client terminal devices 102a-102n are not connected to network 130. According to one embodiment of the invention, any requests that are submitted while a client terminal devices 102a-102n are not connected to network 130 may be stored and propagated from/to the offline client terminal devices 102a-102n when both the source and target client terminal devices 102a-102n are re-connected to network 130. For example, if one of the source and target client terminal devices 102a-102n is not connected to network 130, then requests remain in the corresponding client terminal device 102a-102n for dissemination when the source and target client terminal devices 102a-102n are re-connected to network 130.

According to one embodiment of the invention, any requests that are made from a source client terminal device to target client terminal devices, intermediate server 115a-115n and/or server 120 may be stored for subsequent dissemination if corresponding client terminal devices 102a-102n are not connected to network 130. The request may be stored in storage devices 162a-162n associated with intermediate servers 115a-115n, a storage devices 160 associated with server 120 and/or a memory that is associated with the source client terminal device 102a-102n. Upon reconnection to network 130, intermediate servers 15a-115n, server 120 and/or client terminal devices 102a-102n may cause information stored in storage devices 160, 162a-162n and/or the source client terminal device memory, respectively, to be forwarded to the corresponding target client terminal device 102a-102n.

According to another embodiment, the invention may include features that determine availability information for client terminal devices 102a-102n. The features may detect whether client terminal devices 102a-102n are operating online or offline and may detect a type of network connection for the client terminal devices 102a-102n, such as a wired connection, a wireless connection or other network connection.

According to one embodiment of the invention, client terminal devices 102a-102n may include at least a first unique identifier that is associated with corresponding vehicles 101a-101n in which client terminal devices 102a-102n are located. According to another embodiment of the invention, client terminal devices 102a-102n may include at least a second unique identifier that is associated with at least one trucking company that operates or otherwise manages operations of corresponding vehicles 101a-101n. One of ordinary skill in the art will readily appreciate that the invention may be implemented using individual identifiers, a single identifier that identifies two or more items, and/or other identifier configurations.

According to one embodiment of the invention, client terminal devices 102a-102n may be coupled to a vehicle engine data bus to collect performance data, including engine data, engine run time data, engine idle time data, total engine run time data, average speed data, distance traveled data, fuel consumption data, miles per gallon data, and/or other performance data. According to another embodiment, client terminal devices 102a-102n also may include a global positioning module 110 that captures global positioning data and/or other data corresponding to vehicles 101a-101n. One of ordinary skill in the art will readily appreciate that client terminal device 102 may be coupled to vehicle components via wired and/or wireless connections.

According to one embodiment of the invention, client terminal devices 102a-102n may include one or more software agents that coordinate data capture and data transmission. According to one embodiment, the presence of the agents may be known to users. According to an alternative embodiment, the presence of the agents may not be known to users. According to one embodiment, captured data may be stored locally at client terminal devices 102a-102n and may be batched until a selected criteria is obtained, including passage of a pre-determined amount of time, accumulation of a pre-determined amount of data, occurrence of an event and/or other criteria. Alternatively, client terminal devices 102a-102n may forward captured data to corresponding intermediate servers 115a-115n at a time when the data is gathered, in essentially real-time, or at a time shortly thereafter. According to another embodiment of the invention, client terminal devices 102a-102n may initiate forwarding of the captured data. Alternatively, corresponding intermediate servers 115a-115n may initiate forwarding of the captured data.

According to one embodiment of the invention, intermediate servers 115a-115n may include corresponding communications modules 122a-122n may communicate with corresponding client terminal devices 102a-102n to receive the captured data. The captured data may be stored in corresponding storage devices 162a-162n, may be maintained in a temporary buffer, or may be otherwise retained. According to another embodiment, client terminal devices 102a-102n may obtain captured data including, vehicle carrier data, vehicle production year data, registration data, assigned driver data, engine type data, and/or other captured data. According to one embodiment, merging modules 166a-166n may be provided to capture data from company affiliated client terminal devices 102a-102n, wherein captured data includes the unique identifier, and identifies at least one vehicle and/or at least one vehicle company that is associated with the captured data. Merging modules 166a-1 66n merge the captured data into company affiliated data or vehicle data including, vehicle carrier, vehicle production year data, registration data, assigned driver data, engine type data, and/or other captured data for the corresponding vehicle or affiliated company. According to another embodiment of the invention, intermediate servers 115-115n may include forwarding modules 167a-167n that initiate forwarding of company affiliated data to server 120.

According to another embodiment of the invention, server 120 may include a communications module 122 that communicates with intermediate servers 15a-115n to receive company affiliated data. The company affiliated data may be stored in storage device 160, may be maintained in a temporary buffer, or may be otherwise retained. According to another embodiment, the company affiliated data may include, vehicle carrier data, vehicle production year data, registration data, assigned driver data, engine type data, and/or other company affiliated data for one or more of the companies.

According to one embodiment of the invention, server 120 may include a metrics module 132 that utilizes at least the company affiliated data to determine and record metrics information corresponding to objects including vehicles 101a-101n, vehicle companies, and/or other objects. The metrics information may include road condition information, traffic flow information, traffic pattern information, pollution information, time-based information, distance-based information, wait-time information, vehicle engine information, location information, weather information, vehicle speed information, fuel-efficiency information and/or other information.

According to one embodiment of the invention, server 120 may include an aggregation module 134 that analyzes at least the affiliated company data, the metrics information, and/or other data, to record aggregated data. Aggregated data may include historical data, company-specific data, vehicle-specific data, metrics data and other aggregated data.

According to one embodiment of the invention, server 120 also may include a zone determining module 136 that communicates with global positioning module 110 and/or accesses stored geographic location data to derive and record pre-defined geographic zones. The pre-defined geographic zones may include any geo-encoded area, including irregular-shaped geographic zones. According to one embodiment of the invention, a property of any shape may be outlined or a portion of any property may be outlined to define irregular-shaped geographic zones. Irregular-shaped properties may include a shipping location, a receiving location, a port terminal, a city, a county, or other irregular-shaped properties. By contrast, known applications generate regular-shaped geographic zones, such as circular zones. According to one embodiment of the invention, the pre-defined geographic zones may be created using client terminal devices 102a-102n, server 120, intermediate servers 115a-115n or other systems. The pre-defined geographic zones may be used to monitor vehicle activity within the pre-defined geographic zones, including port terminals, cities, shipping locations, receiving locations and other pre-defined geographic zones. According to one embodiment, sub-zones may be defined within the pre-defined geographic zones. According to one embodiment, vehicle activity may include vehicle speed, vehicle direction, vehicle location, engine idle time, engine emissions output and/or other vehicle or engine activity.

According to another embodiment of the invention, server 120 may include a notification module 138 that generates notifications and/or alerts that are directed to a plurality of parties 170 including government agencies, non-government agencies, dispatchers, vehicle operators, service subscribers, and/or other parties. The notifications and/or alerts may be communicated to the plurality of parties 170 over wired or wireless media 140. The notifications and/or alerts may be generated based on various triggers, including distance from an incident, vehicle engine conditions, type of vehicle trailer, hazardous materials located proximate to pre-defined geographic zones, hazardous materials located within pre-defined geographic zones, time spent within pre-defined geographic zones, issuance of detention billing information, and/or other triggers. The notifications and/or alerts also may be generated based on watches that are set-up to monitor captured data, vehicle company data, metrics information, global positioning data for particular criteria.

According to one embodiment of the invention, server 120 may include a message generating module 142 that generates notifications and/or alerts in real-time. The generated notifications and/or alerts may be delivered in real-time. Alternatively, message generating module 142 may generate the notifications and/or alerts after a pre-determined delay. The generated notifications and/or alerts may be delivered after the pre-determined delay. According to another embodiment of the invention, message generating module 142 may enable users to generate messages for routing to other users. The notifications and/or alerts may be delivered using known communication techniques including electronic mail, mobile telephones, telephone messages, text messages, instant messages, and other communication techniques. The notifications and/or alerts may be delivered through client terminal devices 102a-102n, cell phones or through other communication devices.

According to another embodiment of the invention, client terminal devices 102a-102n may include a corresponding panic button 112 that enables vehicle operators and/or other users to issue real-time notifications of emergencies to a plurality of parties including government agencies, non-government agencies, dispatchers, vehicle operators, service subscribers, and/or other parties. According to one embodiment, emergencies may include traffic incidents, suspected terrorism, hijacking or other emergencies.

According to another embodiment of the invention, client terminal devices 102a-120n may include corresponding alert receiving modules 114 that enable receipt of real-time alerts. According to one embodiment, client terminal devices 102a-102n also may include lights, audible alarms or other indicators to quickly provide real-time alert notification to users, including vehicle occupants and/or other users.

FIG. 1 is provided for illustrative purposes only and should not be considered limitations of the invention. Other configurations will be appreciated by those skilled in the art and are intended to be encompassed by the invention.

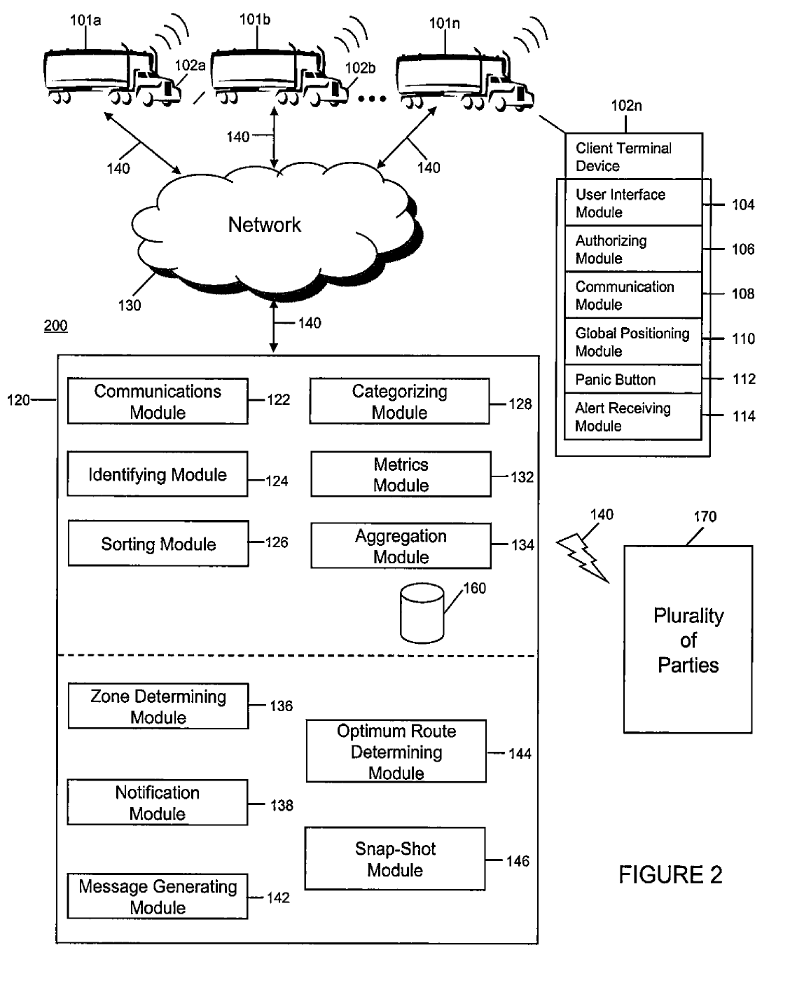

FIG. 2 illustrates an alternative embodiment wherein the functionality of intermediate servers 115a-115n are provided in server 120. Client terminal devices 102a-102n (hereinafter client terminal devices 102) may reside on vehicles 101a-101n (hereinafter vehicles 101), including trucks, trailers, containers and/or other vehicles used within the trucking industry.

According to one embodiment of the invention, client terminal devices 102 may communicate with server 120 via network 130. According to another embodiment of the invention, network 130 may include the Internet. Client terminal devices 102 may communicate via communications media 140, such as, for example, any wired and/or wireless media. Communications between client terminal devices 102 and server 120 may occur substantially in real-time, if the system is connected to the network 130. One of ordinary skill in the art will appreciate that communications may be conducted in various ways and among various devices.

As discussed above with regard to FIG. 1, communications via network 130 may be implemented using current and future language conventions and/or current and future communications protocols that are generally accepted and used for generating and/or transmitting messages over network 130.

According to another embodiment of the invention, one or more client terminal devices 102 may be assigned to vehicle 101. According to another embodiment of the invention, one or more client terminal devices 102 may be assigned directly or indirectly to a user. Regarding indirect assignment, a client terminal device 102 may be assigned to vehicle 101 and the user may be assigned to the same vehicle 101, thereby creating an association between client terminal device 102 and the user.

According to one embodiment of the invention, client terminal devices 102 may be coupled to each other directly and/or indirectly and may communicate via communications module 108. Client terminal devices 102 may include a communications module 108 that is coupled to media 140 such as, for example, any wireless and/or wired media. For example, a user may access client terminal device 102, which is located in an assigned vehicle 101, to request information. The request may be broadcast to a wireless client terminal device 102 that is carried by a target recipient such as another vehicle operator, a dispatcher or other target recipient. Alternatively, communications module 108 may communicate with server 120 to exchange data, wherein the data exchange may occur with or without user awareness of the data exchange. Communications with client terminal devices 102 may occur substantially in real-time if client terminal devices 102 are connected to network 130.

Alternatively, the communications may be delayed for an amount of time if, for example, one or more client terminal devices 102 are not connected to network 130. According to one embodiment of the invention, any requests that are submitted while client terminal devices 102 are not connected to network 130 may be stored and propagated from/to the offline client terminal devices 102 when both the source and target client terminal devices 102 are re-connected to network 130. For example, if one of the source and target client terminal devices 102 is not connected to network 130, then requests remain in the corresponding client terminal device 102 for dissemination when the source and target client terminal devices 102 are re-connected to network 130.

According to one embodiment of the invention, any requests that are made from a source client terminal device to target client terminal devices and/or server 120 may be stored for subsequent dissemination if corresponding client terminal devices 102 are not connected to network 130. The request may be stored in a storage device 160 associated with server 120 and/or a memory that is associated with the source client terminal device 102. Upon reconnection to network 130, server 120 and/or client terminal devices 102 may cause information stored in storage device 160 and/or the source client terminal device memory, respectively, to be forwarded to the corresponding target client terminal device 102.

According to another embodiment, the invention may include features that determine availability information for client terminal devices 102. The features may detect whether client terminal devices 102 are operating online or offline and may detect a type of network connection for client terminal devices 102, such as a wired connection, a wireless connection or other network connection.

According to one embodiment of the invention, client terminal devices 102 may include at least a first unique identifier that is associated with the vehicle 101 in which the client terminal device 102 is located. According to another embodiment of the invention, client terminal devices 102 may include at least a second unique identifier that is associated with at least one trucking company that operates or otherwise manages operations of corresponding vehicle 101. One of ordinary skill in the art will readily appreciate that the invention may be implemented using individual identifiers, a single identifier that identifies two or more items, and/or other identifier configurations.

According to one embodiment of the invention, client terminal devices 102 may be coupled to a vehicle engine data bus to collect performance data, including engine data, engine run time data, engine idle time data, total engine run time data, average speed data, distance traveled data, fuel consumption data, miles per gallon data, and/or other performance data. According to another embodiment, client terminal devices 102 also may include a global positioning module 110 that captures global positioning data and/or other data corresponding to vehicle 101. One of ordinary skill in the art will readily appreciate that client terminal device 102 may be coupled to vehicle components via wired and/or wireless connections.

According to one embodiment of the invention, client terminal devices 102 may include one or more software agents that coordinate data capture and data transmission. According to one embodiment, the presence of the agents may be known to users. According to an alternative embodiment, the presence of the agents may not be known to users. According to one embodiment, captured data may be stored locally at client terminal device 102 and may be batched until a selected criteria is obtained, including passage of a pre-determined amount of time, accumulation of a pre-determined amount of data, occurrence of an event and/or other criteria. Alternatively, client terminal device 102 may forward captured data to server 120 at a time when the data is gathered, in essentially real-time, or at a time shortly thereafter. According to another embodiment of the invention, client terminal device 102 may initiate forwarding of the captured data. Alternatively, server 120 may initiate forwarding of the captured data.

According to one embodiment of the invention, server 120 may include a communications module 122 that communicates with client terminal devices 102 to receive the captured data. The captured data may be stored in storage device 160, may be maintained in a temporary buffer, or may be otherwise retained. According to another embodiment, client terminal devices 102 may obtain captured data including, vehicle carrier data, vehicle production year data, registration data, assigned driver data, engine type data, and/or other captured data. According to one embodiment, an identifying module 124 may be provided to analyze the captured data, including the unique identifier, and identifies at least one vehicle and/or at least one vehicle company that is associated with the captured data. According to another embodiment, a sorting module 126 may be provided to sort the captured data based factors, including a vehicle company identifier, a vehicle, a time of receipt, a day of receipt or other factors.

According to one embodiment of the invention, server 120 may include a categorizing module 128 that associates captured data from a same company. Categorizing module may organize the captured data so that data from a same company may be searched. A metrics module 132 may be provided that utilizes at least the vehicle company data to determine and record metrics information corresponding to objects, including vehicles 101, companies, and/or other objects. The metrics information may include road condition information, traffic flow information, traffic pattern information, pollution information, time-based information, distance-based information, wait-time information, vehicle engine information, location information, weather information, vehicle speed information, fuel-efficiency information and/or other information. According to one embodiment of the invention, time-based information may be defined according to a day, a week, a month, or other time increment.

According to another embodiment of the invention, server 120 may include an aggregation module 134 that analyzes at least the trucking company data, the metrics information, and/or other data, to record aggregated data. Aggregated data may include historical data, company-specific data, vehicle-specific data, metrics data and other aggregated data.

According to one embodiment of the invention, server 120 also may include a zone determining module 136 that communicates with global positioning module 110 and/or accesses stored geographic location data to derive and record pre-defined geographic zones. The pre-defined geographic zones may include any geo-encoded area, including irregular-shaped geographic zones. According to one embodiment of the invention, a property of any shape may be outlined or a portion of any property may be outlined to define irregular-shaped geographic zones. Irregular-shaped properties may include a shipping location, a receiving location, a port terminal, a city, a county, or other irregular-shaped properties. By contrast, known applications generate regular-shaped geographic zones, such as circular zones. According to one embodiment of the invention, the pre-defined geographic zones may be created using client terminal devices 102a-102n, server 120, or other systems. The pre-defined geographic zones maybe used to monitor vehicle activity within the pre-defined geographic zones, including port terminals, cities, shipping locations, receiving locations and other pre-defined geographic zones. According to one embodiment, sub-zones may be defined within the pre-defined geographic zones. According to one embodiment, vehicle activity may include vehicle speed, vehicle direction, vehicle location, and/or other vehicle activity.

According to another embodiment of the invention, server 120 may include a notification module 138 that generates notifications and/or alerts that are directed to a plurality of parties 170 including government agencies, non-government agencies, dispatchers, vehicle operators, service subscribers, and/or other parties. The notifications and/or alerts may be communicated to the plurality of parties 170 over wired or wireless media 140. The notifications and/or alerts may be generated based on various triggers, including distance from an incident, vehicle engine conditions, type of vehicle trailer, hazardous materials located proximate to pre-defined geographic zones, hazardous materials located within pre-defined geographic zones, time spent within pre-defined geographic zones, issuance of detention billing information, and/or other triggers. The notifications and/or alerts also may be generated based on watches that are set-up to monitor captured data, vehicle company data, metrics information, and/or global positioning data, among other watches, for particular criteria.

According to one embodiment of the invention, server 120 may include a message generating module 142 that generates notifications and/or alerts in real-time. The generated notifications and/or alerts may be delivered in real-time. Alternatively, message generating module 142 may generate the notifications and/or alerts after a predetermined delay. The generated notifications and/or alerts may be delivered after the pre-determined delay. According to another embodiment of the invention, message generating module 142 may be configured to enable users to generate messages for routing to other users. The notifications and/or alerts may be delivered using known communication techniques including electronic mail, telephone messages, text messages, instant messages, and other communication techniques. The notifications and/or alerts may be delivered through client terminal devices 102 or through other communication devices.

According to another embodiment of the invention, client terminal devices 102 may include panic buttons 112 that enable vehicle operators and/or other users to issue real-time notifications of emergencies to a plurality of parties including government agencies, non-government agencies, dispatchers, vehicle operators, service subscribers, and/or other parties. According to one embodiment, emergencies may include traffic incidents, suspected terrorism, adverse road conditions or other emergencies.

According to another embodiment of the invention, client terminal devices 102 may include alert receiving modules 114 that enable receipt of real-time alerts. According to one embodiment, client terminal devices 102 also may include lights, audible alarms or other indicators to quickly provide real-time alert notification to users, including vehicle occupants and/or other users.

FIG. 2 is provided for illustrative purposes only and should not be considered limitations of the invention. Other configurations will be appreciated by those skilled in the art and are intended to be encompassed by the invention.

According to one embodiment of the invention illustrated in FIG. 1 and FIG. 2, server 120 may include a snap-shot module 146 that provides real-time information regarding a number of vehicles that are located in a corridor, a number of vehicles that are in-service during a selected time period, a directional flow of vehicles in a corridor, a number of vehicles that are located in pre-defined geographic zones or other real-time information. According to another embodiment of the invention, intermediate servers 115a-115n may include snap-shot module 168a-168n to enable companies to see company specific information. According to the invention, corridors may include interstates, arterial roads or other corridors.

According to another embodiment of the invention illustrated in FIG. 1 and FIG. 2, server 120 may include an optimum route determining module 144 that receives origination and/or destination information, included an address, a landmark, or other location information, from users. Optimum route determining module 144 analyzes the captured data, Internet information, and/or other information, to determine one or more optimum routes from the origination point to the destination point. According to one embodiment of the invention, the optimum route determining module 144 relies on real-time information from various sources to avoid impediments, including traffic congestion, bad weather, vehicle load restrictions, road closures, construction projects and/or other impediments. The optimum route determining module 144 also may consider factors, including mileage, most freeway usage, least freeway usage, and other factors to provide an optimum route.

According to one embodiment of the invention illustrated in FIG. 1 and FIG. 2, a user interface may include user-friendly navigation, including touch screen navigation, voice recognition navigation, command navigation and/other user-friendly navigation. Additionally, alerts, triggers, alarms, notifications and/or other actions, may be provided through text to speech conversion systems. The system also may provide language translation capabilities. According to one embodiment, the invention enables total hands-free operation. According to another embodiment of the invention, visual information may be provided in an easy to follow format, including graphs, charts, maps and other easy to follow formats.

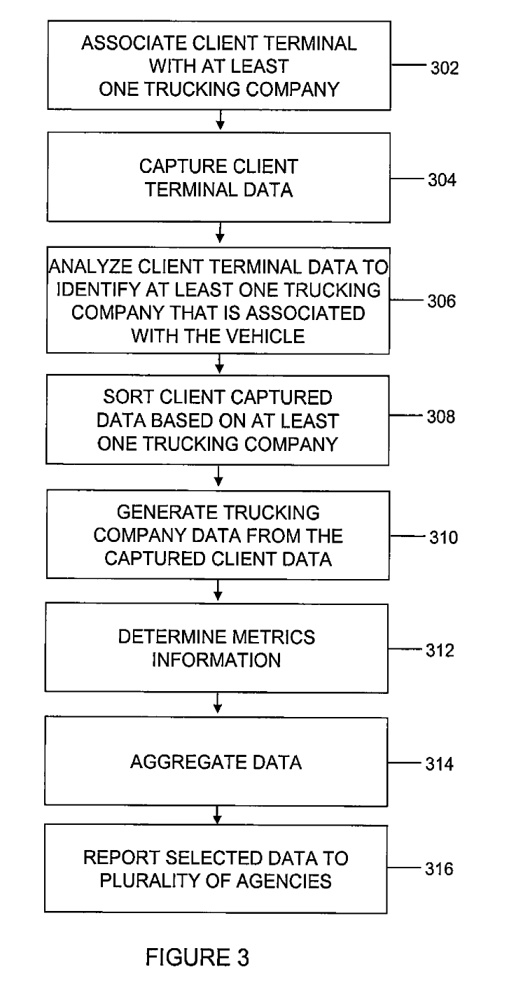

FIG. 3 illustrates a method of monitoring vehicles in a trucking industry and of providing notifications to a plurality of agencies. In operation 302, a client terminal is associated with at least one trucking company. In operation 304, client terminal data is captured, including global positioning data. In operation 306, the captured client terminal data is analyzed to identify at least one trucking company that is associated with the vehicle. In operation 308, captured client terminal data is sorted based on the at least one trucking company and in operation 310 trucking company data is generated from the captured client terminal data for the at least one trucking company. In operation 312, metrics information corresponding to at least one of vehicles and trucking companies is determined based on the trucking company data. In operation 314, at least one of the captured client terminal data, the trucking company data, or the metrics information is aggregated. In operation 316, at least one of the captured client terminal data, the trucking company data, and the metrics information is reported to a plurality of government agencies, a plurality of non-government agencies, or both.

While the preferred forms of the invention have been disclosed, it will be apparent to those skilled in the art that various changes and modifications may be made that will achieve some of the advantages of the invention without departing from the spirit and scope of the invention. For example, the system may be configured to support various other mobile objects. It will be apparent to those reasonably skilled in the art that other components performing the same function may be suitably substituted. Further, the methods of the invention may be achieved in either all software implementations, using the appropriate processor instructions, or in hybrid implementations that utilize a combination of hardware logic and software logic to achieve the same results. Therefore, the scope of the invention is to be determined solely by the appended claims.

1. A vehicle monitoring and notification system that is operated by a plurality of providers for use in a trucking industry, comprising:
(a) a client terminal that resides at a vehicle, the client terminal comprising:
a global positioning system that generates global positioning data;
at least one agent that communicate with the global positioning system to capture client terminal data, including global positioning data; and
a forwarding module that initiates forwarding of the captured client terminal data, wherein the client terminal is associated with at least one trucking company;
(b) at least one intermediate server, which is associated with the plurality of providers, the at least one intermediate server further being associated with a plurality of pre-selected trucking companies, the intermediate server comprising:
a communications module that receives the captured client terminal data from at least one client terminal that is associated with the plurality of pre-selected trucking companies;
a merging module that receives the captured client terminal data and merges the captured client terminal data into trucking company data for the plurality of pre-selected trucking companies;
a forwarding module that initiates forwarding of the trucking company data; and
(c) a data aggregation server, comprising:
a communication module that receives trucking company data from at least one intermediate server that is associated with the plurality of pre-selected trucking companies;
a metrics module that utilizes the trucking company data to determine and record metrics information corresponding to at least one vehicle and at least one trucking company; and
an aggregation module that analyzes one or more of the trucking company data and the metrics information to record aggregated data,
wherein the vehicle monitoring and notification system permits the aggregation and distribution of at least one of (i) the captured client terminal data, (ii) the trucking company data, and (iii) the metrics information, and
wherein the vehicle monitoring and notification system is configured to report at least one of (i) the captured client terminal data, (ii) the trucking company data, and (iii) the metrics information to a plurality of government agencies, a plurality of non-government agencies, or both.

2. The system according to claim 1, further comprising a notification module that generates an alert to at least one of (a) a vehicle (b) an email user (c) government agencies and (d) private businesses, based on (i) the captured client terminal data, (ii) the trucking company data, (iii) the metrics information (iv) the global positioning data, or any combination of (i) to (iv).

3. The system according to claim 1, further comprising a message generating module that enables a user to generate a message for routing to at least one vehicle based on (i) the captured client terminal data, (ii) the trucking company data, (iii) the metrics information (iv) the global positioning data, or any combination of (i) to (iv).

4. The system according to claim 1, further comprising a zone determining module that creates defined zones based on geographic information and determines vehicle activity within the defined zones based on (i) the captured client terminal data, (ii) the trucking company data, (iii) the metrics information (iv) the global positioning data, or any combination of (i) to (iv).

5. The system according to claim 1, wherein the client terminal further comprises an interface that is coupled to at least one vehicle detector.

6. The system according to claim 1, wherein the client terminal further comprises a panic button that provides real-time notification to the at least one government agency, at least one non-government agency, or both.

7. The system according to claim 1, wherein the client terminal further comprises an alert receiving module that receives real-time alerts and provides real-time alert notification to a vehicle occupant.

8. The system according to claim 1, wherein the captured client terminal data includes (i) engine run time, (ii) engine idle time, (iii) average speed, (iv) distance traveled, (v) fuel consumed, (vi) miles per gallon, (vii) current position of the vehicle, or any combination of (i) to (vii).

9. The system according to claim 1, wherein the captured intermediate server data includes information corresponding to (i) a number of vehicles that are located in a corridor, (ii) a number of vehicles that are in-service during a selected time period, (iii) a directional flow of vehicles in the corridor, (iv) a number of vehicles located in a defined zone, or any combination of (i) to (iv).

10. The system according to claim 9, wherein the corridor includes an interstate or an arterial road.

11. The system according to claim 9, wherein the selected time period includes at least one of a particular time of day, hour, day, a week, and a month.

12. The system according to claim 4, wherein the zone determining module enables creation of irregularly-shaped geographic zone and wherein vehicle activity within the irregularly-shaped geographic zone is used to send an alert to the government or non-government agencies.

13. The system according to claim 12, wherein a vehicle wait-time to enter the irregularly-shaped geographic zone is calculated and is used to alert the government or non-government agencies.

14. A vehicle monitoring and notification system for use in a trucking industry, comprising:
(a) a plurality of client terminals that reside at plurality of vehicles, the client terminals comprising:
a global positioning system that generates global positioning data;
one or more agents that communicate with the global positioning system to capture client terminal data, including global positioning data; and
a forwarding module that initiates forwarding of the captured client terminal data, wherein the plurality of client terminals are associated with a plurality of trucking companies; and
(b) a data aggregation server, comprising:
a communications module that receives the captured client terminal data from the plurality of client terminals;
an identifying module that analyzes the captured client terminal data to identify the at least one trucking company that is associated with each vehicle;
a sorting module that sorts the captured client terminal data based on the plurality of trucking companies;
a categorizing module that generates trucking company data from the captured client terminal data for the plurality of trucking companies;
a metrics module that utilizes the trucking company data to determine and record metrics information corresponding to at least one of (i) vehicles and (ii) trucking companies; and
an aggregation module that analyzes at least one of the trucking company data and the metrics information to record aggregated data,
wherein the vehicle monitoring and notification system permits the aggregation and distribution of at least one of (i) the captured client terminal data, (ii) the trucking company data, and (iii) the metrics information, and
wherein the vehicle monitoring and notification system is configured to report at least one of (i) the captured client terminal data, (ii) the trucking company data, and (iii) the metrics information to a plurality of government agencies, a plurality of non-government agencies, or both.

15. The system according to claim 14, further comprising an intermediate server that is associated with a pre-selected trucking company, the intermediate server comprising:
a communications module that receives the captured client terminal data from at least one client terminal that is associated with the pre-selected trucking company;
a merging module that receives the captured client terminal data and merges the captured client terminal data into pre-selected trucking company data for the pre-selected trucking company; and
a memory that stores the pre-selected trucking company data.

16. The system according to claim 14, further comprising a notification module that generates an alert to at least one of (a) a vehicle (b) an email user (c) government agencies and (d) private businesses, based on (i) the captured client terminal data, (ii) the trucking company data, (iii) the metrics information (iv) the global positioning data, or any combination of (i) to (iv).

17. The system according to claim 14, further comprising a message generating module that enables a user to generate a message for routing to at least one vehicle based on (i) the captured client terminal data, (ii) the trucking company data, (iii) the metrics information (iv) the global positioning data, or any combination of (i) to (iv).

18. The system according to claim 14, further comprising a zone determining module that creates defined zones based on geographic information and determines vehicle activity within the defined zones based on (i) the captured client terminal data, (ii) the trucking company data, (iii) the metrics information (iv) the global positioning data, or any combination of (i) to (iv).

19. The system according to claim 14, wherein the client terminal further comprises an interface that is coupled to at least one vehicle detector.

20. The system according to claim 14, wherein the client terminal further comprises a panic button that provides real-time notification to the at least one government agency, at least one non-government agency, or both.

21. The system according to claim 14, wherein the client terminal further comprises an alert receiving module that receives real-time alerts and provides real-time alert notification to a vehicle occupant.

22. The system according to claim 14, wherein the captured client terminal data includes (i) engine run time, (ii) engine idle time, (iii) average speed, (iv) distance traveled, (v) fuel consumed, (vi) miles per gallon, (vii) current position of the vehicle, or any combination of (i) to (vii).

23. The system according to claim 14, wherein the captured intermediate server data includes information corresponding to (i) a number of vehicles that are located in a corridor, (ii) a number of vehicles that are in-service during a selected time period, (iii) a directional flow of vehicles in the corridor, (iv) a number of vehicles located in a defined zone, or any combination of (i) to (iv).

24. The system according to claim 23, wherein the corridor includes an interstate or an arterial road.

25. The system according to claim 23, wherein the selected time period includes at least one of a day, a week, and a month.

26. A method of monitoring vehicles in a trucking industry and of providing notifications, comprising:
providing a client terminal that resides at the vehicle, wherein the client terminal is associated with at least one trucking company;
capturing client terminal data, including global positioning data;
analyzing the captured client terminal data to identify the at least one trucking company that is associated with the vehicle;
determining metrics information corresponding to at least one of vehicles and trucking companies;
aggregating at least one of the captured client terminal data, or the metrics information, and
reporting at least one of the captured client terminal data, and the metrics information to a plurality of government agencies, a plurality of non-government agencies, or both.

27. The method according to claim 26, further comprising generating an alert to at least one of (a) a vehicle (b) an email user (c) government agencies and (d) private businesses, based on (i) the captured client terminal data, (ii) the metrics information, (iii) the global positioning data, or any combination of (i) to (iii).

28. The method according to claim 26, further comprising enabling users to generate a message for routing to at least one vehicle based on (i) the captured client terminal data, (ii) the metrics information, (iii) the global positioning data, or any combination of (i) to (iii).

29. The method according to claim 26, further comprising creating defined zones based on geographic information and determining vehicle activity within the defined zones based on (i) the captured client terminal data, (ii) the metrics information, (iii) the global positioning data, or any combination of (i) to (iii).

30. A vehicle monitoring and notification system that is operated by a plurality of providers for use in a trucking industry, comprising:
(a) a client terminal that resides at a vehicle, the client terminal comprising:
a global positioning system that generates global positioning data;
at least one agent that communicate with the global positioning system to capture client terminal data, including global positioning data; and
a forwarding module that initiates forwarding of the captured client terminal data, wherein the client terminal is associated with at least one trucking company;
(b) at least one intermediate server, which is associated with the plurality of providers, the at least one intermediate server further being associated with a pre-selected trucking company, the intermediate server comprising:
a communications module that receives the captured client terminal data from at least one client terminal that is associated with the pre-selected trucking company;
a second forwarding module that initiates forwarding of the client terminal data;
(c) a data aggregation server, comprising:
a second communications module that receives client terminal data from the intermediate server that is associated with a plurality of pre-selected trucking companies;
a metrics module that utilizes the trucking company data to determine and record metrics information corresponding to at least one vehicle and at least one trucking company; and
a zone determining module that analyzes at least geographic information to determine activity within or surrounding a predefined zone, and
wherein the vehicle monitoring and notification system is configured to report at least one of (i) the captured client terminal data, and (ii) the metrics information to a plurality of government agencies, a plurality of non-government agencies, or both.

31. The system according to claim 30, wherein the geographic zones include irregular-shaped geographic zones.

32. The system according to claim 31, wherein the irregular-shaped geographic zones include a shipping location, a receiving location, a port terminal, a city, or a county.

33. The system according to claim 30, wherein the zone determining module defines sub-zones within the geographic zones.
